(19) United States
(12) Patent Application Publication
(10) Pub. No.: US 2008/0032006 A1
(43) Pub. Date: Feb. 7, 2008

(54) Low fat snack compositions

(76) Inventors: Maria Dolores Martinez-Serna Villagran, Mason, OH (US); Magda El-Nokaly, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/890,091

(22) Filed: Aug. 2, 2007

Related U.S. Application Data
(60) Provisional application No. 60/834,866, filed on Aug. 2, 2006.

(51) Int. Cl. A21D 13/00; A23L 1/0524; A23L 1/0528; A23L 1/053

(52) U.S. Cl. 426/102; 426/103; 426/549; 426/550; 426/560; 426/94; 426/96; 426/99

(57) ABSTRACT

A coated fabricated snack piece that is substantially covered with a coating that contains a gum consisting of alginates, cellulose derivatives, gellan, xanthan, Arabic, pectin and mixtures thereof. The coating may be from about 1% to about 10%, by weight, of the coated fabricated snack piece, and the gum may be present in the coating in a concentration of from about 2% to about 60%, by weight. The carrier is preferably aqueous based, and even more preferably the coating does not comprise starch. Moreover, there is provided a fabricated snack piece made from a sheet of dough, and the dough contains a gum selected from the group consisting of guar, cellulose derivatives, xanthan, Arabic, pectin and mixtures thereof. The gum is present in the dough at a concentration of from about 0.1% to about 2%, by weight, of the dry dough ingredients.

### CROSS REFERENCE TO RELATED APPLICATIONS

This application claims the benefit of U.S. Provisional Application No. 60/834,866 filed Aug. 2, 2006.

### FIELD OF THE INVENTION

The present invention relates to low fat snack compositions and to food products comprising low fat snack compositions, especially fabricated snack products comprising low fat snack compositions.

### BACKGROUND OF THE INVENTION

Fabricated snack products prepared from doughs comprising starch-based materials are well-known in the art. These doughs typically comprise dehydrated potato products such as dehydrated potato flakes, granules, and/or flanules. The doughs can also comprise a number of other starch-based ingredients, such as wheat, corn, rice, tapioca, barley, cassava, and potato starches, as well as flours. These other starch-based ingredients are typically included in the doughs in lesser quantities than the dehydrated potato products.

The advantages of preparing such food products from a dough rather than from sliced, whole potatoes include homogeneity or uniformity in the end food products and the ability to more closely control the separate steps involved in the preparation of the food products. Additionally, preparing fabricated snack products from dough provides the flexibility to formulate such products according to the availability of raw materials and to consumer desires for various textures and flavors.

The fabricated snacks are typically made from pieces cut from the dough which are then fried in oil producing a snack crisp. While the snack crisps can be cooked in a variety of methods that do not involve submersion in oil, frying remains a preferred cooking method. The oil that remains on the surface of the fried snack crisp provides flavor and mouth feel that is desired by consumers of snack products. But there has been a growing trend toward the reduction in fat in all food items, and specifically, in snack foods. And snack crisps that are fried in oil absorb oil that does not necessarily contribute to taste and mouth feel as much as the oil on the surface. As such, the absorbed oil adds fat and calories to the snack product while adding little or no sensory benefit.

Accordingly, snacks that are fried and absorb less than normal amount of oil also provide the benefit of being crispier and crunchier than snacks with the full fat content. Accordingly, it is an object of the present invention to provide a low fat snack composition that absorbs less oil when fried. This and other objects of the invention will become apparent from the following disclosure.

### SUMMARY OF THE INVENTION

The present invention relates to a coated fabricated snack piece that is substantially covered with a coating that contains a gum selected from the group consisting of alginates, cellulose derivatives, gellan, xanthan, Arabic, pectin and mixtures thereof. The coating comprises from about 1% to about 10%, by weight, of the coated fabricated snack piece, and the gum may be present in the coating in a concentration of from about 0.5% to about 60%, preferably from about 5% to about 40%, by weight. The carrier is preferably aqueous based, and even more preferably the coating does not comprise starch.

In another aspect of the present invention a coated fabricated snack piece is cut from a sheet of dough and the dough contains from about 10% to about 90%, by weight, dehydrated potato products. The dough may further contain optional ingredients selected from the group consisting of rice flour, rice starch, wheat, corn, tapioca, barley, cassava, potato starches, emulsifiers and mixtures thereof. Typically, the dough will contain from about 5% to about 35%, by weight, water. The coated fabricated snack piece is fried in oil to produce a snack crisp. The total fat concentration in the snack crisp is from about 32% to about 3%, preferably from about 25% to about 5%, more preferably from about 15% to about 7%, by weight. The coating may optionally contain some starch ingredients, preferably less than about 30%, more preferably less than about 10%, and even more preferably less than about 1%, by weight of the coating composition.

In yet another aspect of the present invention, there is provided a fabricated snack piece made from a sheet of dough, and the dough contains a gum selected from the group consisting of guar, cellulose derivatives, xanthan, Arabic, pectin and mixtures thereof. The gum is present in the dough at a concentration of from about 0.1% to about 2%, preferably from about 0.3% to about 1.5%, more preferably from about 0.3% to about 0.9%, and even more preferably from about 0.5% to about 0.7%, by weight, of the dry dough ingredients.

In yet another aspect of the present invention, there is provided a fabricated snack piece made from a sheet of dough that is coated with proteins such as whey protein concentrate, or any other hydrophilic polymer for example, silicas and the like.

### DETAILED DESCRIPTION OF THE INVENTION

### A. Definitions

As used herein, the term “fabricated” refers to food products made from doughs comprising flour, meal, and/or starch, such as those derived from tubers, grains, legumes, cereals, or mixtures thereof.

As used herein, the term “coating” refers to a thin film that is applied on the surface of the dough.

As used herein, the term “low-fat” means that the amount of digestible fat, as regulated by the United States Food & Drug Administration is reduced versus the full fat product. The amount of digestible fat present in a product to be labeled low-fat is referenced in terms of a reference serving size

As used herein, the term “fat” is used interchangeably with the terms “shortening” and “oil” unless otherwise specified. The terms “fat”, “shortening” or “oil” refer to edible fatty substances in a general sense, including natural or synthetic fats and oils consisting essentially of triglycerides, such as, for example soybean oil, corn oil, cottonseed oil, sunflower oil, palm oil, coconut oil, canola oil, fish oil, lard and tallow, which may have been partially or completely hydrogenated or modified otherwise; as well as edible fatty materials having properties similar to triglycerides; non-digestible fats, oils or fat substitutes; reduced calorie fats; emulsifiers; and mixtures thereof are also included in the term.

As used herein, “added fat” refers to fat, both digestible and non-digestible, which is added to the dough over and above that amount inherently present in the flour.

As used herein “cohesive dough” and “sheetable dough” are used interchangeably and mean dough capable of being placed on a smooth surface and rolled or extruded to the desired final thickness or extruded through a die orifice without tearing or forming holes.

As used herein, “dehydrated potato products” includes, but is not limited to, potato flakes, potato flanules, potato granules, potato agglomerates, any other dehydrated potato material, and mixtures thereof.

As used herein, intact sheets of flakes and sheet sections are included in the term “potato flakes.”

As used herein “flanules” refers to those dehydrated potato products described in U.S. Pat. No. 6,287,622, issued Sep. 11, 2001, to Villagran et al.

As used herein, “starch” refers to a native or an unmodified carbohydrate polymer having repeating anhydroglucose units derived from materials such as, but not limited to, wheat, corn, tapioca, sago, rice, potato, oat, barley, and amaranth, and to modified starches including but not limited to hydrolyzed starches such as maltodextrins, high amylose corn maize, high amylopectin corn maize, pure amylose, chemically substituted starches, crosslinked starches, and mixtures thereof.

As used herein, “starch-based flour” refers to high polymeric carbohydrates composed of glucopyranose units, in either natural, dehydrated (e.g., flakes, granules, meal) or flour form. Starch-based flour can include, but is not limited to, potato flour, potato granules, potato flanules, potato flakes, corn flour, masa corn flour, corn grits, corn meal, rice flour, buckwheat flour, oat flour, bean flour, barley flour, tapioca, and mixtures thereof. For example, the starch-based flour can be derived from tubers, legumes, grain, or mixtures thereof.

As used herein, “modified starch” refers to starch that has been physically or chemically altered to improve its functional characteristics. Suitable modified starches include, but are not limited to, pregelatinized starches, low viscosity starches (e.g., dextrins, acid-modified starches, oxidized starches, enzyme modified starches), stabilized starches (e.g., starch esters, starch ethers), cross-linked starches, starch sugars (e.g. glucose syrup, dextrose, isoglucose) and starches that have received a combination of treatments (e.g., cross-linking and gelatinization) and mixtures thereof. When calculating the level of modified starch according to the present invention, modified starch (e.g., gelatinized starch) that is inherent in other dough ingredients such as rice flour and the dehydrated potato products is not included; only the level of modified starch added over and above that contained in other dough ingredients is included in the term “modified starch.”

As used herein the term “added water” refers to water that has been added to the dry dough ingredients. Water that is inherently present in the dry dough ingredients, such as in the case of the sources of flours and starches, is not included in the “added water.”

As used herein the term “emulsifier” refers to emulsifier that has been added to the dough ingredients. Emulsifiers that are inherently present in the dough ingredients, such as in the case of the potato flakes (where emulsifier is used as a processing aid during manufacturing), are not included in the term “emulsifier.”

As used herein “rapid viscosity unit” (RVU) is an arbitrary unit of viscosity measurement roughly corresponding to centipoise, as measured using the RVA analytical method herein. (12 RVU equal approximately 1 centiPoise)

By the term “dry blend” it is meant herein the dry raw material mixed together prior to processing of the materials so mixed.

All percentages are by weight unless otherwise specified.

All documents cited herein are, in relevant part, incorporated by reference; the citation of any document is not to be construed as an admission that it is prior art with respect to the present invention.

### B. Fabricated Snack Product Preparation

Although the use of gums to produce low fat snack compositions will be described primarily in terms of a preferred fabricated snack product, it should be readily apparent to one skilled in the art that the low fat snack compositions of the present invention can be used in the production of any suitable food products. The production of the preferred fabricated snack product is set forth in detail below.

1. Dough Formulation

The preferred doughs of the present invention comprise a dry blend and added water. Preferably, the doughs comprise from about 50% to about 80% dry blend and from about 20% to about 50% added water. The doughs can further comprise optional ingredients.

a. Dry Blend

Preferred doughs comprise from about 50% to about 80% dry blend, preferably from about 60% to about 75% dry blend.

Preferred dry blends comprise from about 2% to about 98%, preferably from about 3% to about 95%, and more preferably from about 4% to about 90%, by weight, starch-based flour and the remainder other ingredients. Suitable sources of starch-based flour include tapioca flour, oat flour, wheat flour, rye flour, rice flour, rice starch material, non-masa corn flour, peanut flour, and dehydrated potato products (e.g., dehydrated potato flakes, potato granules, potato flanules, mashed potato materials, and dried potato products). Other flours can also include fruit and vegetable powders, for example apple flour, sweep potato flour, green pea flour, and the like The flours can be blended to make snacks of different compositions, textures, and flavors.

b. Gums

The dough of the present invention can optionally include a gum selected from the group consisting of Guar, Chitosan, cellulose derivatives, Xanthan, Arabic, pectin and mixtures thereof. Other gums are also suitable for use herein and can be selected from the group consisting of polysaccharides, polyglucose materials, hydrocolloids, cellulose derivatives and mixtures thereof. Cellulose derivatives include, but are not limited to, carboxyl methyl cellulose, hydroxyl propyl cellulose, hydroxyl propyl methyl cellulose and mixtures thereof. Alternatively, as described in greater detail below, the gums can be applied as a coating to the sheeted dough. Of course, the gums can be both added to the dough and applied as a coating. Regardless of how the gum is added to the fabricated snack piece it provides a substantial fat reduction benefit in the final fried snack crisp. More specifically, the total fat concentration in the snack crisp is from about 32% to about 3%, preferably from about 25% to about 5%, more preferably from about 15% to about 7%, by weight after frying.

When a fabricated snack piece is fried in oil, the water present in the dough evaporates and exits the dough. As the water vapor bubbles to the surface of the snack crisp it creates small capillaries which the oil can then fill. This process of oil displacing water in the dough increases the amount of fat in the final snack crisp. As mentioned briefly above, the oil on the surface of a snack crisp provides good flavor and a pleasant mouth feel. The oil absorbed in the interior of a snack crisp, however, adds fat and calories while providing little added sensory benefits for the consumer. As such, eliminating the adsorbed fat does not change the taste of the snack crisp, but does provide a much healthier snack. While not wanting to be bound by any one theory, it is believed that the gums act as film formers creating a network or structure on the surface of the dough that seals or clogs capillaries formed when water evaporates out of the dough. In addition, the hydrophilic nature of the gums repels the oil and therefore decreases the rate of oil absorbed, leaving a monolayer of oil on the surface of the dough. This oil layer is bound to the dough by the hydrophobic groups of the gum. Once the capillaries are clogged or sealed, the oil surrounding the fabricated snack piece is deterred from entering the snack piece. Hence, the fat content of the final snack crisp is reduced.

The gums are preferably present in the dough from about 0.1% to about 2%, preferably from about 0.3% to about 1.5%, more preferably from about 0.3% to about 0.9%, and even more preferably from about 0.5% to about 0.7%, by weight, of the dry dough ingredients.

The gums can be added in a dry form or they can be pre-hydrated. It is preferred to pre-hydrate the gum before adding it to the dough. Pre-hydration aids in the formation of mesomorphic phases, such as Liquid Crystals. The Liquid Crystal phase enhances the effectiveness of the gum and increase the level of fat reduction in the final snack crisp.

Useful polysaccharide gums include nonionic, anionic, and cationic polysaccharides. Preferred nonionics include hydroxylpropyl cellulose polymers, such as the Klucel series available from Hercules, Inc. of Naplesville Ill., and Xanthan gum available from Kelco, of San Diego, Calif. Some of the preferredanionic polymers are the sodium alginates, also available from Kelco, and sodium carboxymethyl cellulose polymers available from Hercules.

c. Added Water

Preferred dough compositions of the present invention comprise from about 20% to about 50% added water, preferably from about 25% to about 40% added water. If optional ingredients, such as maltodextrin or corn syrup solids, are added as a solution or syrup, the water in the syrup or solution is included as added water. The amount of added water also includes any water used to dissolve or disperse ingredients.

d. Other Optional Ingredients

Any suitable optional ingredient may be added to the doughs of the present invention. Such optional ingredients can include, but are not limited to, modified starches, native starches, gum, reducing sugar, emulsifier, and mixtures thereof. Optional ingredients are preferably included at a level ranging from about 0% to about 25% in the dough. Optionally, calcium can be added to the coating or to the dough to strengthen the network film. Optionally, reducing sugar can be added to the dough. While the reducing sugar content can be dependent upon that of the potatoes that were employed to prepare the dehydrated potato product, the amount of reducing sugar in the fabricated snack products can be controlled by adding suitable amounts of a reducing sugar such as maltose, lactose, dextrose, or mixtures thereof to the dough.

An ingredient that can optionally be added to the dough to aid in its processability is emulsifier. An emulsifier is preferably added to the dough composition prior to sheeting the dough. The emulsifier can be dissolved in a fat or in a polyol fatty acid polyester such as Olean™. Suitable emulsifiers include lecithin, mono- and diglycerides, diacetyl tartaric acid esters and propylene glycol mono- and diesters and polyglycerol esters. Polyglycerol emulsifiers such as monoesters of hexapolyglycerols, can be used. Particularly preferred monoglycerides are sold under the trade names of Dimodan available form Danisco®, New Century, Kans. and DMG 70, available from Archer Daniels Midlands Company, Decatur, Ill.

2. Dough Preparation

The doughs of the present invention can be prepared by any suitable method for forming sheetable doughs. Typically, a loose, dry dough is prepared by thoroughly mixing together the ingredients using conventional mixers. Preferably, a pre-blend of the wet ingredients and a pre-blend of the dry ingredients are prepared; the wet pre-blend and the dry pre-blend are then mixed together to form the dough. Hobart® mixers are preferred for batch operations and Turbulizer® mixers are preferred for continuous mixing operations. Alternatively, extruders can be used to mix the dough and to form sheets or shaped pieces.

As discussed above, the gums can be added in a dry form or they can be pre-hydrated. It is preferred to pre-hydrate the gum before adding it to the dough. Pre-hydration aids in the formation of mesomorphic phases, such as Liquid Crystals. The Liquid Crystal phase enhances the effectiveness of the gum and increase the level of fat reduction in the final snack crisp.

a. Sheeting

Once prepared, the dough is then formed into a relatively flat, thin sheet. Any method suitable for forming such sheets from starch-based doughs can be used. For example, the sheet can be rolled out between two counter rotating cylindrical rollers to obtain a uniform, relatively thin sheet of dough material. Any conventional sheeting, milling and gauging equipment can be used. The mill rolls should preferably be heated to from about 90° F. (32° C.) to about 135° F. (57° C.). In a preferred embodiment, the mill rolls are kept at two different temperatures, with the front roller being hotter than the back roller. The dough can also be formed into a sheet by extrusion.

Doughs of the present invention are usually formed into a sheet having a thickness ranging from about 0.015 to about 0.10 inches (from about 0.038 to about 0.25 cm), and preferably to a thickness ranging from about 0.02 to about 0.08 inches (from about 0.05 to about 0.2 cm), and most preferably from about 0.02 inches to about 0.05 inches (0.15 to 0.13 cm).

The dough sheet is then formed into snack pieces of a predetermined size and shape. The snack pieces can be formed using any suitable stamping or cutting equipment. The snack pieces can be formed into a variety of shapes. For example, the snack pieces can be in the shape of ovals, squares, circles, a bowtie, a star wheel, or a pin wheel. The pieces can be scored to make rippled chips as described by Dawes et al. in PCT Application No. PCT/US95/07610, published Jan. 25, 1996 as WO 96/01572.

b. Coating

The use of gums in snacks also has a positive effect on texture. When the gums are added to the dough directly, the expansion of the product increases, creating bubbles in the finished product. This increased expansion has a positive effect on the appearance and mouth melt of the fried snack crisp. The resulting snack is lighter and crispier. On the other hand, the use of gums in the coating can be used to control the expansion of the finished product. Moreover, the application of a gum containing coating typically increases the density of the snacks by reducing the level of bubbles on the surface. However, by tailoring the composition of the gum, such as concentration of the gum in the coating, the amount of coating on the chip, and composition of the chip, the texture of the chip can be controlled.

As described above, adding gums to the dough from which fabricated snack pieces are made, provides substantial and beneficial fat reduction in the final fried snack crisp. This benefit can also be obtained by coating the fabricated snack piece with a gum containing solution where the gum is selected from the group consisting of alginates, cellulose derivatives, gellan, xanthan, Arabic, pectin and mixtures thereof. Cellulose derivatives include, but are not limited to, carboxyl methyl cellulose, hydroxyl propyl cellulose, hydroxyl propyl methyl cellulose and mixtures thereof. The coating comprises from about 1% to about 10%, by weight, of the coated fabricated snack piece, and the gum may be present in the coating in a concentration of from about 2% to about 60%, preferably from about 5% to about 40%, by weight. The carrier for the coating is preferably aqueous based, and even more preferably the coating does not comprise starch. While the coatings are described herein with respect to fabricated snack pieces, the gum coating of the present invention can also be used for coating other fried foods, dog foods, dog biscuits, baby foods, crackers, extruded products, and breads.

The coating can be applied by any number of commercially available techniques and equipment. The sheeted dough, or fabricated snack pieces cut from the dough can be immersed in a bath of the coating solution. The time in the bath, the concentration of the solution, and the temperature of the bath will largely determine the amount of gum applied to the surface. The coating solution can be sprayed or even printed onto the dough surface via commercially available sprayers and printers. It is preferred that both side of the sheeted dough or fabricated snack piece cut from the dough be coated, although some benefit will be obtained by coating only one side.

Moreover, the gum containing coating can be used as a carrier for other optional ingredients, for example, oil or water based flavors, colorants, herbs, spices and the like.

c. Frying

After the snack pieces are formed, they are cooked until crisp to form fabricated snack products. The snack pieces can be fried in a fat composition comprising digestible fat, non-digestible fat, or mixtures thereof. For best results, clean frying oil should be used. The free fatty acid content of the oil should preferably be maintained at less than about 1%, more preferably less than about 0.3%, in order to reduce the oil oxidation rate.

In a preferred embodiment of the present invention, the frying oil has less than about 25% saturated fat, preferably less than about 20%. This type of oil improves the lubricity of the finished fabricated snack products such that the finished fabricated snack products have an enhanced flavor display. The flavor profile of these oils also enhance the flavor profile of topically seasoned products because of the oils' lower melting point. Examples of such oils include sunflower oil containing medium to high levels of oleic acid.

In another embodiment of the present invention, the snack pieces are fried in a blend of non-digestible fat and digestible fat. Preferably, the blend comprises from about 20% to about 90% non-digestible fat and from about 10% to about 80% digestible fat, more preferably from about 50% to about 90% non-digestible fat and from about 10% to about 50% digestible fat, and still more preferably from about 70% to about 85% non-digestible fat and from about 15% to about 30% digestible fat. Other ingredients known in the art can also be added to the edible fats and oils, including antioxidants such as TBHQ, tocopherols, ascorbic acid, chelating agents such as citric acid, and anti-foaming agents such as dimethylpolysiloxane.

It is preferred to fry the snack pieces at temperatures of from about 275° F. (135° C.) to about 420° F. (215° C.), preferably from about 300° F. (149° C.) to about 410° F. (210° C.), and more preferably from about 350° F. (177° C.) to about 400° F. (204° C.) for a time sufficient to form a product having about 6% or less moisture, preferably from about 0.5% to about 4%, and more preferably from about 1% to about 2.5% moisture. The exact frying time is controlled by the temperature of the frying fat and the starting water content of the dough, which can be easily determined by one skilled in the art.

Preferably, the snack pieces are fried in oil using a continuous frying method and are constrained during frying. This constrained frying method and apparatus is described in U.S. Pat. No. 3,626,466 issued Dec. 7, 1971 to Liepa. The shaped, constrained snack pieces are passed through the frying medium until they are fried to a crisp state with a final moisture content of from about 0.5% to about 4%, preferably from about 1% to about 2.5%.

Any other method of frying, such as continuous frying or batch frying of the snack pieces in a non-constrained mode, is also acceptable. For example, the snack pieces can be immersed in the frying fat on a moving belt or basket.

The fabricated snack products made from this process typically have from about 32% to about 3%, and preferably from about 25% to about 5%, and 15% to 7% total fat (i.e., combined non-digestible and digestible fat). If a higher fat level is desired to further improve the flavor or lubricity of the fabricated snack products, an oil, such as a triglyceride oil, can be sprayed or applied by any other suitable means onto the fabricated snack products when they emerge from the fryer, or when they are removed from the mold used in constrained frying. Preferably, the triglyceride oils applied have an iodine value greater than about 75, and most preferably above about 90.

Oils with characteristic flavor or highly unsaturated oils can be sprayed, tumbled or otherwise applied onto the fabricated snack products after frying. Preferably triglyceride oils and non-digestible fats are used as a carrier to disperse flavors and are added topically to the fabricated snack products. These include, but are not limited to, butter flavored oils, natural or artificial flavored oils, herb oils, and oils with potato, garlic, or onion flavors added. This allows the introduction of a variety of flavors without having the flavor undergo browning reactions during the frying. This method can be used to introduce oils which would ordinarily undergo polymerization or oxidation during the heating necessary to fry the snacks.

### D. Analytical Methods

1. Water Absorption Index (WAI)

a. Dry Ingredients and Flour Blend:

In general, the terms “Water Absorption Index” and “WAI” refer to the measurement of the water-holding capacity of a carbohydrate based material as a result of a cooking process. (See e.g. R. A. Anderson et al., Gelatinization of Corn Grits By Roll- and Extrusion-Cooking, 14(1):4 CEREAL SCIENCE TODAY (1969).)

The WAI for a sample is determined by the following procedure:

(1) The weight to two decimal places of an empty centrifuge tube is determined.

(2) Two grams of dry sample are placed into the tube. If a finished product (i.e. a food product such as a snack chip) is being tested, the particle size is first reduced by grinding the product in a coffee grinder until the pieces sift through a US #40 sieve. The ground sample (2 g) is then added to the tube.

(3) Thirty milliliters of water are added to the tube.

(4) The water and sample are stirred vigorously to insure no dry lumps remain.

(5) The tube is placed in a 86° F. (30° C.) water bath for 30 minutes, repeating the stirring procedure at 10 and 20 minutes.

(6) The tube is then centrifuged for 15 minutes at 3,000 rpm.

(7) The water is then decanted from the tube, leaving a gel behind.

(8) The tube and contents are weighed.

(9) The WAI is calculated by dividing the weight of the resulting gel by the weight of the dry sample:
WAI=([weight of tube and gel]−[weight of tube])÷[weight of dry sample])

b. Finished Snack Product

The oil is removed from the product using a Carver Lab Press (Model #C). The fried product is placed into a cylinder. The cylinder is put into the press and the hand lever is pressed until the pressure reaches 15,000 lbs per sq. inch (1.03×10⁸ Pa) after the oil is removed from the product. The product is removed from the cylinder. Steps (1)-(9) above for measuring the WAI of Dry Ingredients and Flour Blend are then followed.

2. Rheological Properties Using the Rapid Visco Analyzer (RVA)

The rheological properties of the dry ingredients, flour blends, and finished products are measured using the Rapid Visco Analyzer (RVA) model RVA-4. The RVA was originally developed to rapidly measure α-amylase activity in sprouted wheat. This viscometer characterizes the starch quality during heating and cooling while stirring the starch sample. The Rapid Visco Analyzer (RVA) is used to directly measure the viscous properties of the starches, and flours. The tool requires about 2 to 4 g of sample and about 25 grams of water.

For best results, sample weights and the water added should be corrected for the sample moisture content, to give a constant dry weight. The moisture basis normally used is 14% as is, and correction tables are available from Newport Scientific. The correction formulae for 14% moisture basis are:
M2=(100−14)×M1/(100−W1)
W2=25.0+(M1−M2)

where

M1=sample mass and is about 3.0 g

M2=corrected sample mass

W1=actual moisture content of the sample (% as is)

The water and sample mixture is measured while going through a pre-defined profile of mixing, measuring, heating and cooling, as set-up using Standard Profile (1) of the instrument. This test provides dough viscosity information that translates into flour quality.

The key parameters used to characterize the present invention are pasting temperature, peak viscosity, peak viscosity time and final viscosity.

RVA Method

Dry Ingredients and Flour Blend:

(1) Determine moisture (M) of sample from air oven.

(2) Calculate sample weight (S) and water weight (W).

(3) Place sample and water into canister.

(4) Place canister into RVA tower and run the Standard Profile (1).

3. Method for Measuring Fat in the Finished Product

Acid Hydrolysis for fat measurement on the finished chip was conducted by Covance Laboratories Inc. (3301 Kinsman Blvd., Madison, Wis. 53704). Official Methods of Analysis of AOAC International, 18^{th} Ed., Methods 922.06 and 954.02, AOAC International, Gaithersburg, Md., USA, (2005).

### E. Examples

### Examples 1-5

Dough compositions are prepared from the dry blends set forth in the Table I below. The dough compositions comprise 65% dry blend and 35% added water. Maltodextrin is first dissolved in the added water, then the remaining ingredients are blended in a Turbulizer® mixer to form a loose, dry dough.

The dough is sheeted by continuously feeding it through a pair of sheeting rolls forming an elastic continuous sheet without pin holes. Sheet thickness is controlled to about 0.02 inches (0.05 cm). The back roll is heated to about 90° F. (32° C.) and the front roll is heated to about 135° F. (57° C.).

The dough sheet is then cut into oval fabricated shaped pieces and fried in a constrained frying mold at about 400° F. (204° C.) for about 8 seconds. The frying oil is cottonseed oil.

The final snack crisps have a crisp texture, fast mouth-melt and clean flavor.

TABLE I

| | Example 1 | Example 2 | Example 3 | Example 4 | Example 5 |
|---|---|---|---|---|---|
| Dry Ingredients | (%) | (%) | (%) | (%) | (%) |
| Rice Flour (GL1080), Sage | 53 | 52.5 | 52.5 | 10 | 10 |
| V, Houston, TX. | | | | | |
| Acetylated rice starch | 10 | 10 | 10 | 0 | 0 |
| (Remygel 663), REMY, | | | | | |
| Brussels | | | | | |
| Corn Meal, Cargill, | 15 | 15 | 15 | 12 | 12 |
| Maltodextrin (Grain | 5 | 5 | 5 | 6 | 6 |
| Processing) | | | | | |
| Potato Flakes (Winnemuca | 17 | 17 | 17 | 64 | 63.5 |
| Farms), Nevada | | | | | |
| Wheat Starch | 0 | 0 | 0 | 0 | 8 |
| Hydroxypropylcellulose* | 0 | 0.5 | 0 | 0 | 0.5 |
| (HPC EF- Klucel), Aqualon, | | | | | |
| Carboxymethylcellulose* | 0 | 0.0 | 0 | 0 | 0 |
| (CMC 8H9), Aqualon. | | | | | |
| Xanthan Gum* (EF), | 0 | 0 | 0.5 | 0 | 0 |
| Kelco, | | | | | |
| Total (%) | 100 | 100 | 100 | 100 | 100 |
| % Fat of finished product | 27 | 19 | 21 | 30 | 25 |
| Water Absorption Index | | | | | |
| Density (g/cc) | | | | | |

*Gums in this example are added as dry ingredients in the formula and then mixed with the water and processing aid at ˜140° C.

### Examples 6-8

Dough and fabricated snack pieces are made with the ingredients listed in Table I using the same process described in Examples 1-5. However, in Examples 6-8 the gums are hydrated prior to mixing with other ingredients, water, and emulsifier. Hydration of the gums is accomplished by adding the powdered gums to the vortex of well-agitated water at the optimum temperature based on the viscosity of the gums: for HPC at room temperature, for CMC at temperatures below 40° C. The rate of addition must be slow enough to permit particles to separate in water. Addition of the powder should be completed, however, before any appreciable viscosity build up is obtained in the solution. The rate of agitation then may be reduced, but continued until a gel-free solution is obtained. Throughout the mixing period, solution temperature should be maintained below 35° C. The ingredients used in the hydration and their concentration are given in Table II.

TABLE II

| Dispersion | Example 6 | Example 7 | Example 8 |
|---|---|---|---|
| Gum (from Examples 1-5) | HPC EF | CMC 7LF | CMC 9H4F |
| Concentration | 10% | 5% | 1% |
| Water temperature | 25° C. | <40° C. | <40° C. |
| Mixing speed | 8000 rpm | 8000 rpm | 8000 rpm |
| Mixing time | 5 min | 10 min | 15 min |
| Apparent Viscosity | Low | Low | High |

### Examples 9-12

Coatings can also be used to reduce fat when applied on the dough surface of fabricated snacks. Table III gives the ingredients and compositions of the coating, which can be applied to any of the dough sheets described in Examples 1-8 above.

TABLE III

| | Example 9 | Example 10 | Example 11 | Example 12 |
|---|---|---|---|---|
| | Coating 1 | Coating 2 | Coating 3 | Coating 4 |
| Hydroxypropylcellulose (HPC EF), | 10 | 0 | 10 | 25 |
| Hercules-Aqualon, Wilmington, DE | | | | |
| Carboxymethyl Cellulose (CMC | 0 | 3 | 0 | 0 |
| 9H4F), Aqualon, Wilmington, DE | | | | |
| Corn Syrup Solids | 5 | 0 | 0 | 10 |
| Xanthan Gum, CPKelco, San Diego, CA | 0 | 0 | 0 | 15 |
| Water | 85 | 97 | 90 | 50 |

### Examples 13-15

Examples 13, 14 and 15 are comparative examples showing the benefit of the present invention. Example 13 is a snack crisp produced with no gum in the dough and no coating. Example 14 is a similar base chip with no gum in the dough, but comprising a gum containing coating. Example 15 is a snack crisp with gum in the dough and a coating in the gum. The fat content for these three examples is given in the last line of Table IV and it can be seen that the fat content of Examples 14 and 15 is much less than comparative Example 13.

The coatings are sprayed on the surface of the sheeted dough (0.021 in thickness) with a modified Power Painter (5.4 GPH WIDE SHOT), Wagner, Minneapolis Minn. The modification of the sprayer consisted in setting a tight inlet and outlet hoses to a tank instead of using the attached bottle. The sprayer was installed vertically pointing the ground to spray the dough as it was passing underneath it. The coating is applied directly on the dough pieces after the excess dough is separated. The dough pieces were sprayed on both sides. The percent addition of coating on the surface of the dough was approximately 10%, by weight.

TABLE IV

| | Example 13 | Example 14 | Example 15 |
|---|---|---|---|
| | (g) | (g) | (g) |
| Dry Ingredients In Dough | | | |
| Potato Flakes | 60.0 | 60.0 | 60.0 |
| Rice Flour (GL 1080) | 170.7 | 170.7 | 170.7 |
| Yellow Pregel Corn Meal | 52.1 | 52.1 | 52.1 |
| Remygel 663 | 34.7 | 34.7 | 34.7 |
| Corn Syrup Solids | 27.8 | 27.8 | 27.8 |
| hydroxypropyl cellulose | 0.0 | 0.0 | 1.7 |
| (HPC) (dry addition) | | | |
| GMO emulsifier | 3.0 | 3.0 | 3.0 |
| water (city) | 150.0 | 150.0 | 150.0 |
| Coatings | | | |
| Caboxymethyl Cellulose | 0 | 0 | 0 |
| (CMC8H4F) | | | |
| Xanthan gum | 0 | 0 | 0 |
| Hydroxypropyl cellulose | 0 | 5 | 5 |
| (HPC) | | | |
| Water (city) | 0 | 95 | 95 |
| Fat content (%) | 24.9 | 17.4 | 14.5 |

### INCORPORATION BY REFERENCE

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A coated fabricated snack piece that is substantially covered with a coating and wherein the coating comprises a gum selected from the group consisting of alginates, cellulose derivatives, gellan, xanthan, arabic, pectin and mixtures thereof.

2. The coated fabricated snack piece of claim 1, wherein the coating comprises from about 1% to about 10%, by weight, of the coated fabricated snack piece.

3. The coated fabricated snack piece of claim 1, wherein the gum comprises from about 2% to about 60%, by weight, of the coating.

4. The coated fabricated snack piece of claim 1, wherein the carrier is aqueous based.

5. The coated fabricated snack piece of claim 1, wherein calcium is also present in the snack.

6. The coated fabricated snack piece of claim 1, wherein the coating comprises starch ingredients, which are present at less than about 30%, by weight, of the coating.

7. The coated fabricated snack piece of claim 1, wherein the fabricated snack piece if made from a sheet of dough and wherein the dough comprises from about 10% to about 90%, by weight, dehydrated potato products.

8. The coated fabricated snack piece of claim 7, wherein the dough further comprises optional ingredients selected from the group consisting of rice flour, rice starch, wheat, corn, tapioca, barley, cassava, potato starches, emulsifiers, fruit and vegetable powders and mixtures thereof.

9. The coated fabricated snack piece of claim 1, wherein the dough comprises from about 5% to about 35%, by weight, water.

10. The coated fabricated snack piece of claim 1, wherein the coated fabricated snack piece is fried in oil to produce a snack crisp.

11. The coated fabricated snack piece of claim 1, wherein the coated fabricated snack piece is baked and then fried in oil to produce a snack crisp.

12. The snack crisp of claim 10, wherein the total fat concentration in the snack crisp is from about 32% to about 3%, by weight.

13. A fabricated snack piece made from a sheet of dough wherein the dough comprises a gum selected from the group consisting of guar, cellulose derivatives, xanthan, arabic, pectin, and mixtures thereof and the gum is from about 0.1% to about 2%, by weight, of the dry dough ingredients.

14. The fabricated snack piece of claim 13, wherein the fabricated snack piece is made from a sheet of dough and wherein the dough comprises from about 10% to about 90%, by weight, dehydrated potato products.

15. The fabricated snack piece of claim 14, wherein the dough further comprises optional ingredients selected from the group consisting of rice flour, rice starch, wheat, corn, tapioca, barley, cassava, potato starches, emulsifiers and fruit and vegetable powders and mixtures thereof.

16. The fabricated snack piece of claim 13, wherein the dough comprises from about 5% to about 35%, by weight, water.

17. The fabricated snack piece of claim 13, wherein the fabricated snack piece is fried in oil to produce a snack crisp.

18. The snack crisp of claim 17, wherein the total fat concentration in the snack crisp is from about 32% to about 3%, by weight.

19. A fabricated snack piece made from a sheet of dough wherein the dough comprises a gum selected from the group consisting of guar, chitosan, cellulose derivatives, xanthan, arabic, pectin and mixtures thereof, and wherein the fabricated snack piece is substantially covered with a coating and wherein the coating comprises a gum selected from the group consisting of alginates, cellulose derivatives, gellan, xanthan, arabic, pectin and mixtures thereof.

20. The fabricated snack piece of claim 19, wherein the fabricated snack piece is fried in oil to produce a snack crisp.

21. The snack crisp of claim 20, wherein the total fat concentration in the snack crisp is from about 25% to about 3%, by weight.

22. The fabricated snack piece of claim 13, further comprising calcium in combination with the gum wherein the calcium is present at from about 0.5% to about 4%, by weight, of the dry blend.

23. A coated fabricated snack piece that is substantially covered with a coating and wherein the coating comprises a gum selected from the group consisting of polysaccharides, polyglucose materials, hydrocolloids, cellulose derivatives and mixtures thereof.

24. A fabricated snack piece is made from a sheet of dough wherein the dough comprises a gum selected from the group consisting of polysaccharides, polyglucose materials, hydrocolloids, cellulose derivatives and mixtures thereof.
